(19) United States
(12) Patent Application Publication
(10) Pub. No.: US 2026/0249495 A1
(43) Pub. Date: Aug. 27, 2026

(54) Drywall Bead Cutting Tool With Angle-Selectable Anvil, Shaped Bead-Receiving Channel, and Repeatable-Length Stop

(71) Applicant: Gerald Douillard, Sugar Hill, GA (US)

(72) Inventor: Gerald Douillard, Sugar Hill, GA (US)

(21) Appl. No.: 19/644,980

(22) Filed: Apr. 10, 2026

Related U.S. Application Data
(63) Continuation-in-part of application No. 18/142,866, filed on May 3, 2023.

(51) Int. Cl. B26B 17/02; B26B 29/06

(52) U.S. Cl. CPC B26B 17/02; B26B 29/06

(57) ABSTRACT

A drywall bead cutting tool includes pivotable handles, a blade movable along a defined blade path, and a bead-receiving channel having a shaped cross-section corresponding to a drywall bead profile. An adjustable anvil is positioned beneath the bead-receiving channel for a plurality of cutting angles. A mechanical linkage operatively connects the handles to the blade to drive the blade through the bead-receiving channel during actuation. The tool may include a ratcheting blade-advance mechanism having a plurality of fixed blade-indexing stops and a pawl arm configured to sequentially engage the stops to advance the blade in discrete increments. A biasing element may return the pawl arm to a default position after each increment. A length-stop surface defines a repeatable cut length for each cutting operation. The combination of the shaped channel, anvil, incremental blade-advance mechanism, and repeatable-length stop enables consistent and accurate cutting of drywall beads at predetermined lengths and angles.

### CROSS-REFERENCE TO RELATED APPLICATIONS

This application is a continuation-in-part of U.S. patent application Ser. No. 18/142,866, filed May 3, 2023.

### TECHNICAL FIELD

The present disclosure relates to cutting tools for drywall finishing materials, and more particularly to a handheld device configured to cut drywall beads at selectable angles and at repeatable lengths.

### BACKGROUND

Drywall beads are commonly used to reinforce and finish corners, edges, and transitions in wallboard installations. Conventional cutting tools often lack the ability to produce consistent cut lengths, require multiple tools to achieve angled cuts, or do not provide a stable interface conforming to the bead profile. Existing devices also fail to provide a guided blade path ensuring accurate alignment between the blade and the bead. There remains a need for a drywall bead cutting tool providing a shaped bead-receiving channel, selectable anvil, mechanical linkage, and repeatable-length stop.

### SUMMARY

The present disclosure is directed to a drywall bead cutting tool that includes pivotable handles, a blade movable along a defined blade path, a shaped bead-receiving channel, a rotatable anvil for selectable cutting angles, and a length-stop surface defining repeatable cut lengths. In some embodiments, the tool further includes an internal ratcheting blade-advance mechanism configured to incrementally advance the blade in discrete, repeatable increments during a cutting stroke. The mechanism may include a plurality of fixed blade-indexing stops and a pawl arm configured to sequentially engage the stops as the handles are actuated. Engagement between the pawl arm and the stops produces controlled, stepwise advancement of the blade along the blade path, thereby improving cutting force, stability, and repeatability. A biasing element may return the pawl arm to a default position after each increment. The combination of the shaped bead-receiving channel, selectable anvil, repeatable-length stop, and incremental blade-advance mechanism enables consistent, accurate cutting of drywall beads at predetermined lengths and angles.

In one embodiment, a drywall bead cutting tool includes an upper handle and a lower handle pivotably connected to one another; a blade mounted to the upper handle and movable along a defined blade path; a bead-receiving channel has a shaped cross-section corresponding to a drywall bead profile; an anvil positioned beneath the bead-receiving channel, the anvil being adjustable to a plurality of cutting angles relative to the blade path;
a mechanical linkage operatively connecting the upper handle to the blade such that movement of the upper handle toward the lower handle forces the blade through the bead-receiving channel; and a length-stop surface positioned within or adjacent to the bead-receiving channel, the length-stop surface defining a repeatable cut length for each actuation of the handles.

In an embodiment, the anvil is rotatably adjustable relative to the cutting tool for a particular cutting angle of the plurality of cutting angles.

In an embodiment, the bead-receiving channel includes a first cutout for straight cuts and a second cutout for angled cuts.

In an embodiment, the anvil is rotatably adjustable and includes discrete detent positions corresponding to predetermined cutting angles.

In an embodiment, the mechanical linkage has a pivoting arm coupled to the blade and configured to translate handle movement into downward blade motion.

In an embodiment, the blade is removably secured by a fastener accessible from the exterior of the tool.

In an embodiment, the length-stop surface is adjustable to vary the repeatable cut length.

In an embodiment, the bead-receiving channel is formed as an interchangeable insert.

In an embodiment, the cutting tool includes an internal mechanical linkage including a pivoting arm configured to rotate about a fixed axis in response to movement of the upper handle.

In an embodiment, the pivoting arm engages a blade carrier interface to guide the blade along the defined blade path.

In an embodiment, a biasing element is configured to urge the pivoting arm toward a default position.

In an embodiment, the mechanical linkage is housed within a structural enclosure that constrains the motion of the pivoting arm.

In an embodiment, a method of cutting a drywall bead includes: inserting a drywall bead into a bead-receiving channel having a shaped cross-section corresponding to the bead; advancing the bead until it contacts a length-stop surface defining a repeatable cut length; rotating an anvil beneath the bead-receiving channel to a selected cutting angle; and pressing an upper handle toward a lower handle to drive a blade along a blade path through the bead-receiving channel, thereby cutting the bead at the selected angle and repeatable length.

In an embodiment, a method of constructing a drywall bead cutting tool includes: pivotably connecting an upper handle to a lower handle; mounting a blade to the upper handle; installing a bead-receiving channel having a shaped cross-section corresponding to a drywall bead; mounting a rotatable anvil beneath the bead-receiving channel; assembling a mechanical linkage between the upper handle and the blade; and installing a length-stop surface configured to define a repeatable cut length.

### BRIEF DESCRIPTION OF THE DRAWINGS

The drawings presented herein show illustrative embodiments of the disclosure. They do not illustrate all embodiments. Other embodiments may be used in addition to or instead of the illustrative embodiments. Details that may be apparent or unnecessary may be omitted to save space or for more effective illustration. Some embodiments may be practiced with additional components or steps and/or without all the components or steps that are illustrated. When the same numeral appears in different drawings, it refers to the same or like components or steps. The drawings are not intended to depict every feature of every implementation nor relative dimensions of the depicted elements, and are not drawn to scale.

FIG. 1 is a perspective view of a drywall bead cutting tool according to an illustrated embodiment.

FIG. 2 is a plan view of the tool of FIG. 1.

FIG. 3 is a side view of the tool of FIG. 1.

FIG. 4 is an underside view of the tool of FIG. 1.

FIG. 5 is a cross-sectional view of the tool showing an internal structure.

FIG. 6 is a view of a an internal mechanical linkage.

FIG. 7 is a view of the tool position on a platform in a pre-cutting orientation according to an illustrated embodiment.

FIG. 8 is a view of an initial cutting operation of a drywall bead according to an illustrative embodiment.

FIG. 9 is a view of a mid-cutting operation showing progressive advancement of the blade through a drywall bead according to an illustrative embodiment.

FIG. 10 is a view of the tool after completing a cut and retracting according to an illustrative embodiment.

FIG. 11 is a view of the cut bead segments positioned closer together according to an illustrated embodiment.

FIG. 12 is a view of an angled cut produced by the tool according to an illustrative embodiment.

### DETAILED DESCRIPTION

In the following description, numerous specific details are set forth to clearly describe various specific embodiments disclosed herein. One skilled in the art, however, will understand that the subject matter of the present disclosure may be practiced without all of the specific details discussed below. In other instances, well-known features may not have been described so as not to obscure the invention with unnecessary detail regarding known features.

As used herein, the term “and/or” is to be interpreted broadly is to be understood to refer to all or some of the elements. For example, “at least one of (a) and/or (b) means the teaching pertains only to element (a), or only to element (b), or to both element (a) and element (b). In another example, “at least one of (a), (b), and/or (c), means the teaching pertains to only element (a), or only to element (b), or only element (c), or to elements (a) and (b), elements (a) and (c), elements (b) and (c), or to all of (a), (b) and (c).

Also, it is to be understood that the phraseology and terminology used herein is for the purpose of description and should not be regarded as limiting. The use of “including,” comprising, “ or ”having“ and variations thereof herein is meant to encompass the items listed thereafter and equivalents thereof as well as additional items. Unless limited otherwise, the terms ”connected,“ coupled,” and “mounted,” and variations thereof herein are used broadly and encompass direct and indirect connections, couplings, and mountings. In addition, the terms “connected” and “coupled” and variations thereof are not restricted to physical or mechanical connections or couplings.

### Overview

A drywall bead cutting tool is provided that incorporates a guided blade path, a shaped bead-receiving channel, a selectable-angle anvil, and mechanisms for producing consistent, repeatable cut lengths. The tool includes pivotable handles that drive a blade downward through a bead positioned within the bead-receiving channel. The channel includes a shaped interior surface corresponding to the profile of a drywall bead, thereby stabilizing the bead during cutting and maintaining alignment between the bead and the blade.

A rotatable anvil is positioned beneath the bead-receiving channel. Rotation of the anvil changes the orientation of the bead relative to the blade path, enabling straight cuts, angled cuts, and other predetermined cutting orientations. In some embodiments, the anvil includes discrete detent positions corresponding to commonly used cutting angles.

The tool further includes an internal mechanical linkage that translates handle movement into controlled blade motion. In certain embodiments, the linkage incorporates a ratcheting blade-advance mechanism configured to incrementally advance the blade in discrete, repeatable increments during a cutting stroke. The mechanism may include a plurality of fixed blade-indexing stops and a pawl arm that sequentially engages the stops as the handles are actuated. Engagement between the pawl arm and the stops produces stepwise advancement of the blade along the defined blade path, improving cutting force, stability, and repeatability. A biasing element may return the pawl arm to a default position after each increment.

A length-stop surface is positioned at the end of the bead-receiving channel. The bead is advanced until it contacts the stop surface, thereby defining a repeatable cut length. In some embodiments, the stop surface is adjustable to vary the cut length. The combination of the shaped bead-receiving channel, selectable anvil, repeatable-length stop, and incremental blade-advance mechanism enables consistent, accurate cutting of drywall beads at predetermined lengths and angles.

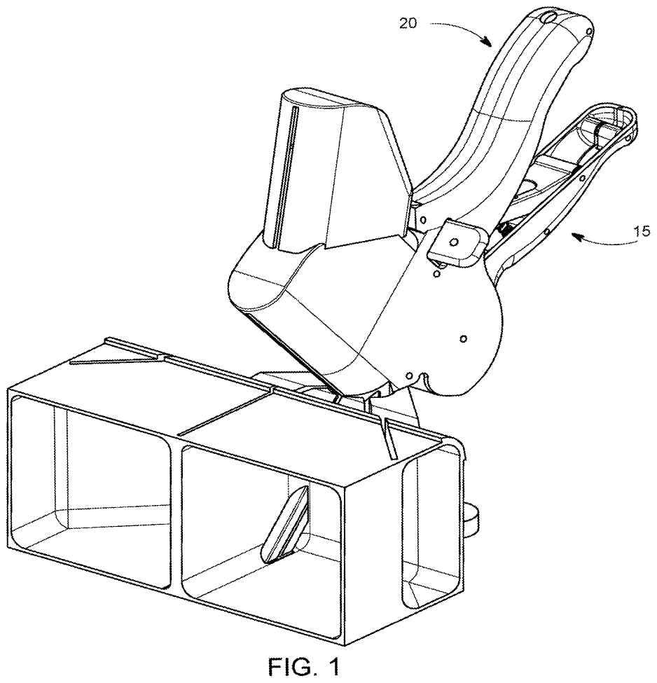

### General Structure (FIGS. 1-4)

As shown in FIG. 1, the drywall bead cutting tool includes an upper handle 15 and a lower handle 20 pivotably connected to one another in a scissor-like configuration. The handles 15, 20 are pivotably connected and define the primary actuation mechanism.

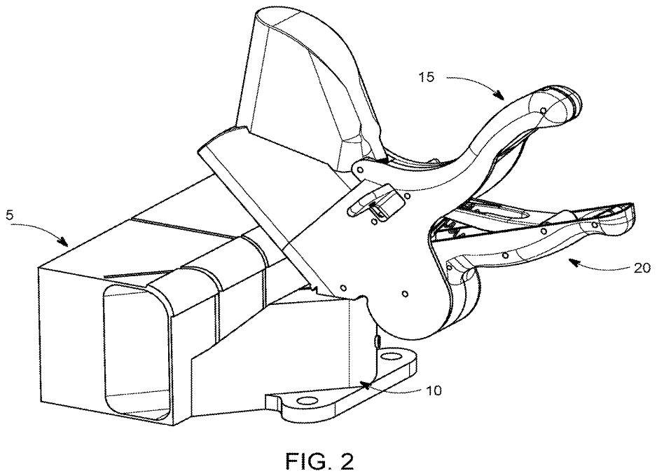

As shown in FIG. 2, the tool includes a housing 10 supporting the handle assembly. A central region 5 is shown but the internal structure is shown in subsequent drawings.

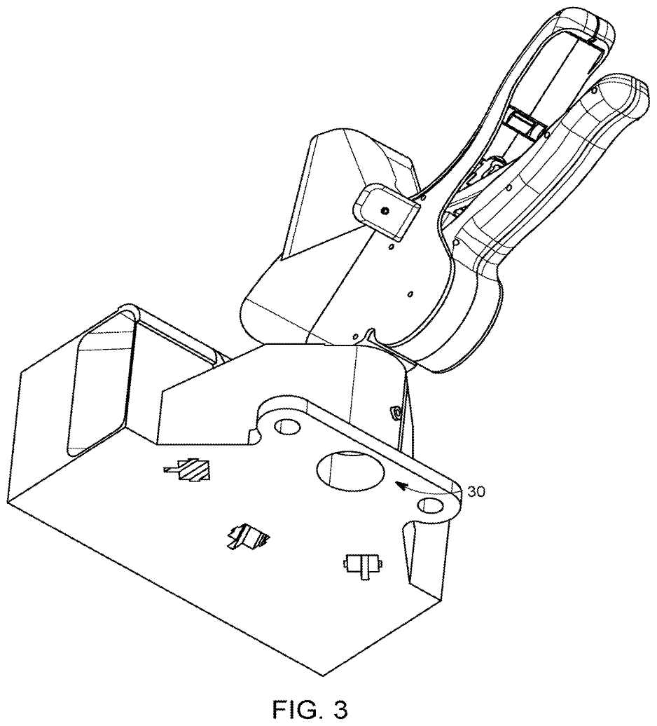

As shown in FIG. 3, an anvil 30 is positioned beneath the tool body. The anvil 30 supports the bead during cutting.

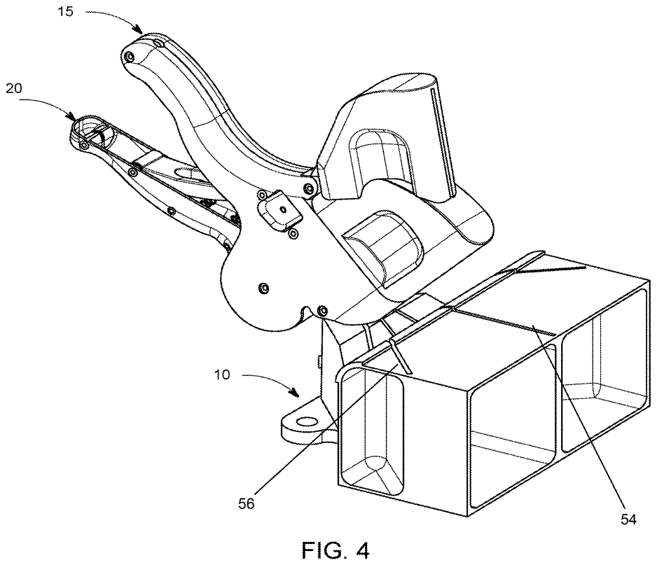

As shown in FIG. 4, the underside of the tool includes the housing 10 and handle structure.

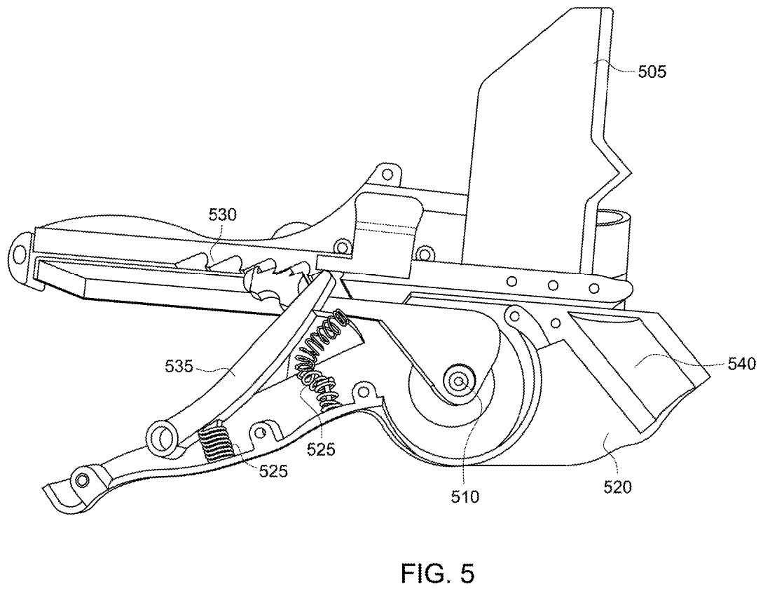

### Bead-Receiving Channel (FIG. 5)

FIG. 5 illustrates a cross-sectional view of the tool showing internal geometry. The cross-section reveals the relationship between the blade, the bead-receiving region, the anvil, and the surrounding housing. The cross-section also illustrates the alignment of the blade path relative to the bead-receiving region.

More particularly, FIG. 5 illustrates an internal ratcheting mechanism configured to advance the blade in discrete increments during actuation of the handles. A plurality of fixed, spaced-apart blade-indexing stops (530) is formed along an interior surface of the housing (520). A blade-advancing arm or pawl arm (535) is pivotably mounted about a pivot point (510) and is biased toward a default position by a biasing element (525). Movement of the upper handle toward the lower handle causes the pawl arm (535) to rotate and sequentially engage the stops (530). Engagement between the pawl arm and each successive stop advances the blade carrier along the defined blade path by a fixed increment.

The spacing of the stops (530) defines the magnitude of each blade-advance increment, thereby producing a controlled, repeatable progression of the blade through the bead-receiving channel. The biasing element (525) returns the pawl arm (535) to its initial position after each increment, enabling the arm to engage the next stop during continued handle actuation. The ratcheting interaction between the pawl arm and the stops provides mechanical advantage, reduces required user force, and ensures stable, guided blade movement throughout the cutting stroke.

In some embodiments, the incremental blade-advance mechanism operates in conjunction with the length-stop surface positioned at the end of the bead-receiving channel 540. The length-stop surface defines the longitudinal position of the bead, while the ratcheting mechanism defines the incremental advancement of the blade, thereby producing consistent cut lengths and improved cutting accuracy.

More particularly, the bead-receiving channel 540 may be positioned directly above the anvil region, may have a concave, shaped interior profile. The bead-receiving channel is aligned with the blade path, meaning the blade would descend through it. Also, the bead receiving channel 540 may be structurally separate from the ratcheting mechanism (530, 535, 525), as the channel is not part of the linkage. The bead-receiving channel has at least two cutout regions or openings, consistent with a straight-cut slot, and an angled-cut slot.

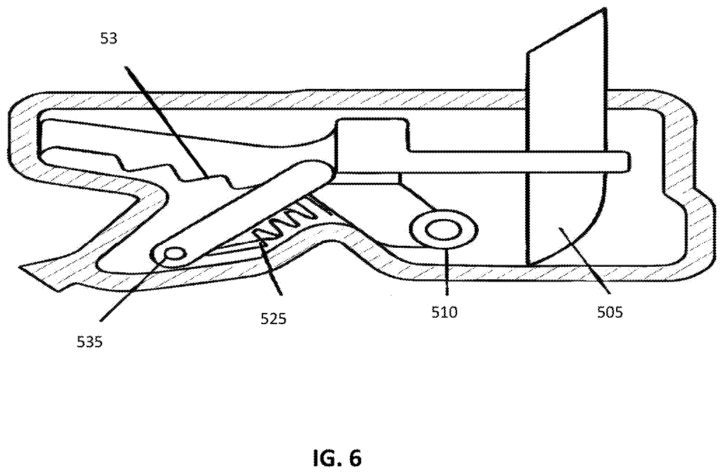

### Internal Mechanical Linkage (FIG. 6)

FIG. 6 illustrates a pivoting arm (610) rotating about a pivot point (630), a biasing element (620) urging the arm toward a default position, and a blade-carrier interface (640) engaged by the arm. A housing (650) constrains the mechanical linkage. Movement of the upper handle causes the pivoting arm to drive the blade downward along a defined blade path.

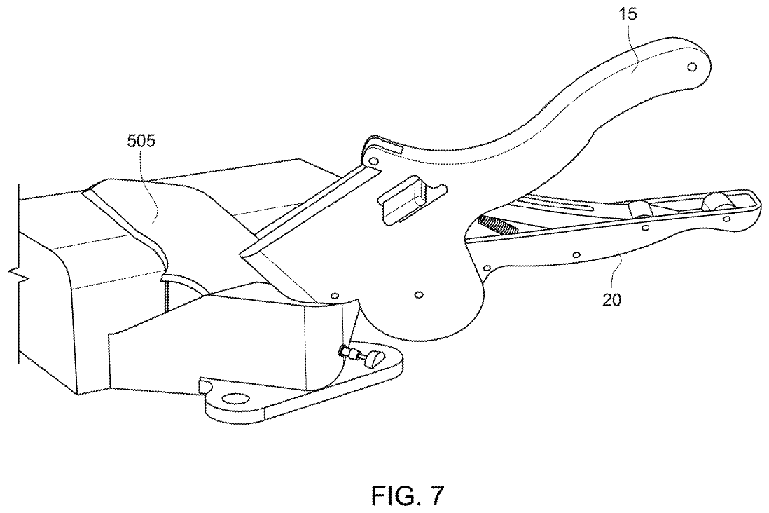

### Pre-Cutting Orientation (FIG. 7)

FIG. 7 illustrates the tool positioned on a platform with a drywall bead placed beneath the blade. To use the cutting tool, a drywall bead is inserted into the bead-receiving channel. The bead is aligned with the bead-receiving region, and the tool is in a ready-to-cut orientation. The bead is advanced until it contacts the length-stop surface. The anvil is rotated to a desired cutting angle. The upper handle is then pressed toward the lower handle, causing the mechanical linkage to drive the blade downward along the blade path. The blade passes through the straight-cut slot or angled-cut slot, depending on the selected angle, thereby cutting the bead at the desired angle and repeatable length.

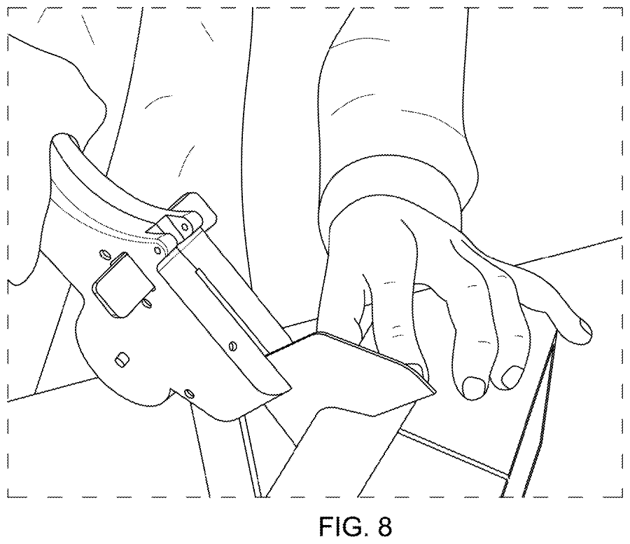

### Cutting Sequence (FIGS. 8-11)

FIG. 8 illustrates an initial cutting operation in which the blade begins to engage the drywall bead.

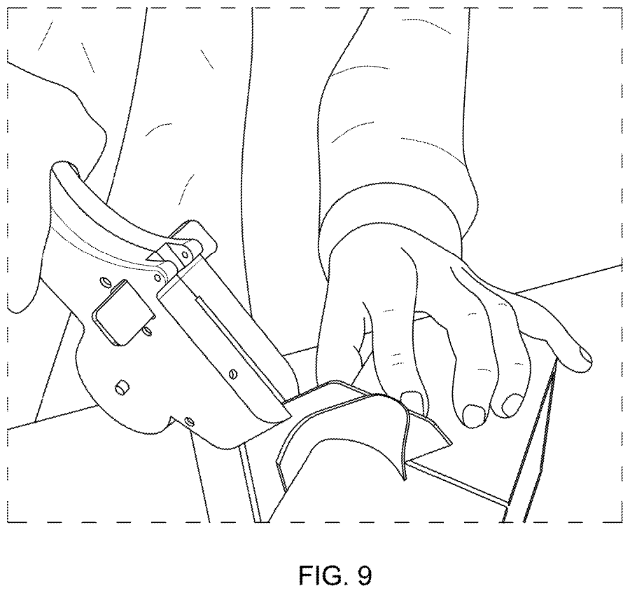

FIG. 9 illustrates a mid-cutting operation in which the blade has progressed further through the bead.

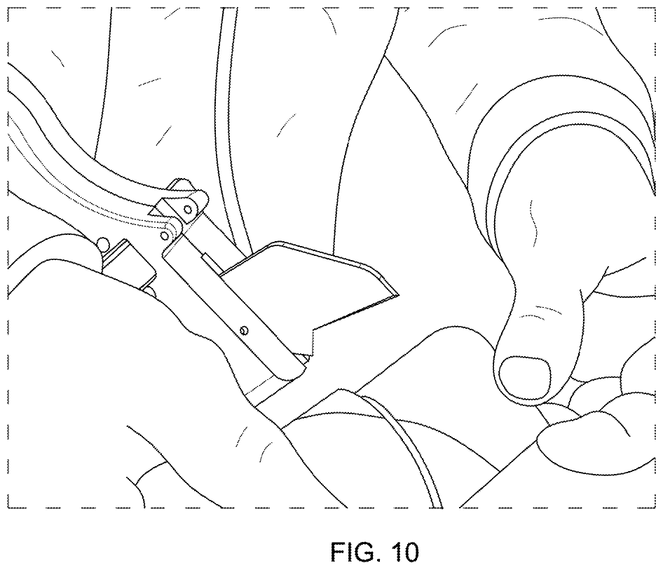

FIG. 10 illustrates the tool after completing the cut, with the blade retracted and the bead fully severed.

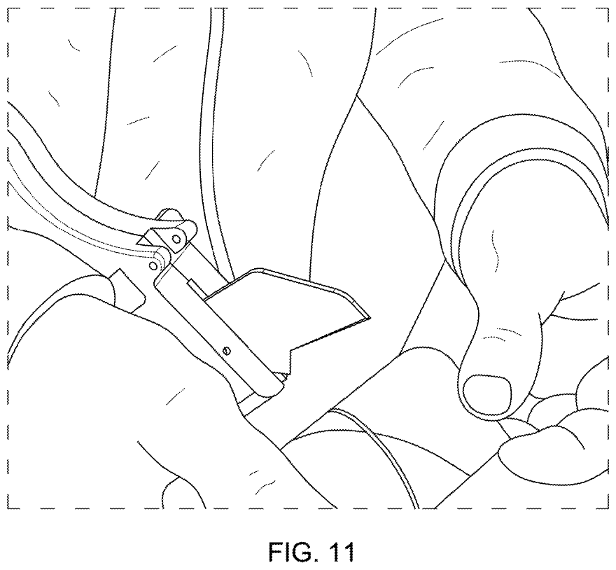

FIG. 11 illustrates the cut bead segments positioned closer together following retraction of the tool.

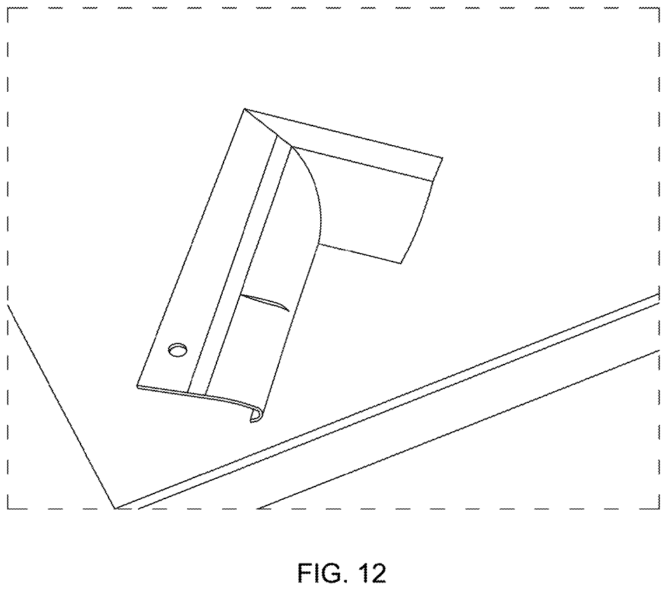

### Angled Cut (FIG. 12)

FIG. 12 illustrates an angled cut produced by the tool, demonstrating the ability to cut drywall beads at non-perpendicular angles.

### Construction of the Cutting Tool

The tool may be assembled by pivotably connecting the upper and lower handles, mounting the blade to the upper handle, installing the mechanical linkage, installing the bead-receiving channel, mounting the rotating anvil, and installing the length-stop mechanism.

### CONCLUSION

As used in this specification and the appended claims, the singular forms “a,‘ ’an,” and “the” include plural references unless the content clearly dictates otherwise. The term plurality” includes two or more referents unless the content clearly dictates otherwise. Unless defined otherwise, all technical and scientific terms used herein have the same meaning as commonly understood by one of ordinary skill in the art to which the disclosure pertains.

The foregoing detailed description of exemplary and preferred embodiments is presented for purposes of illustration and disclosure in accordance with the requirements of the law. It is not intended to be exhaustive nor to limit the invention to the precise form(s) described, but only to enable others skilled in the art to understand how the invention may be suited for a particular use or implementation. The possibility of modifications and variations will be apparent to practitioners skilled in the art. No limitation is intended by the description of exemplary embodiments which may have included tolerances, feature dimensions, specific operating conditions, engineering specifications, or the like, and which may vary between implementations or with changes to the state of the art, and no limitation should be implied therefrom. Applicant has made this disclosure with respect to the current state of the art, but also contemplates advancements and that adaptations in the future may take into consideration of those advancements, namely in accordance with the then current state of the art. It is intended that the scope of the invention be defined by the Claims as written and equivalents as applicable reference to a claim element in the singular is not intended to mean “one and only one’ unless explicitly so stated. Moreover, no element, component, nor method or process step in this disclosure is intended to be dedicated to the public regardless of whether the element, component, or step is explicitly recited in the claims. No claim element herein is to be construed under the provisions of 35 U.S.C. Sec. 112, paragraph (f), unless the element is expressly recited using the phrase “means for”, and no method or process step herein is to be construed under those provisions unless the step, or steps, are expressly recited using the phrase “step(s) for . . . ”.

1. A drywall bead cutting tool comprising:
an upper handle and a lower handle pivotably connected to one another;
a blade mounted to the upper handle and movable along a defined blade path;
a bead-receiving channel having a shaped cross-section corresponding to a drywall bead profile;
an anvil positioned beneath the bead-receiving channel, the anvil being adjustable to a plurality of cutting angles relative to the defined blade path;
a mechanical linkage operatively connecting the upper handle to the blade such that movement of the upper handle toward the lower handle forces the blade through the bead-receiving channel; and
a length-stop surface positioned within or adjacent to the bead-receiving channel, the length-stop surface defining a repeatable cut length for each actuation of the upper handle and the lower handle.

2. The cutting tool of claim 1, wherein the anvil is rotatably adjustable relative to a particular cutting angle of the plurality of cutting angles.

3. The cutting of claim 1, wherein the bead-receiving channel includes a first cutout for straight cuts and a second cutout for angled cuts.

4. The cutting tool of claim 1, wherein the anvil includes discrete detent positions corresponding to the plurality of cutting angles.

5. The cutting tool of claim 1, wherein the mechanical linkage comprises a pivoting arm coupled to the blade and configured to translate handle movement into downward blade motion.

6. The cutting tool of claim 1, wherein the blade is removably secured by a fastener accessible from an exterior of the tool.

7. The cutting tool of claim 1, wherein the length-stop surface is adjustable to vary the repeatable cut length.

8. The cutting tool of claim 1, wherein the bead-receiving channel is formed as an interchangeable insert.

9. The cutting tool of claim 1, further comprising an internal mechanical linkage including a pivoting arm configured to rotate about a fixed axis in response to movement of the upper handle.

10. The cutting tool of claim 1, wherein a pivoting arm engages a blade-carrier interface to guide the blade along the defined blade path.

11. The cutting tool of claim 10, further comprising a biasing element urging the pivoting arm toward a default position.

12. The cutting tool of claim 10, wherein the mechanical linkage is housed within a structural enclosure that constrains the motion of the pivoting arm.

13. The cutting tool of claim 1, further comprising a plurality of fixed blade-indexing stops positioned along an interior surface of the tool and configured to define discrete blade-advance increments.

14. The cutting tool of claim 13, further comprising a pawl arm configured to sequentially engage the blade-indexing stops during movement of the upper handle toward the lower handle.

15. The cutting tool of claim 14, wherein engagement between the pawl arm and successive blade-indexing stops advances the blade along the defined blade path in discrete increments.

16. The cutting tool of claim 14, further comprising a biasing element configured to return the pawl arm to a default position after each engagement with a blade-indexing stop.

17. A method of cutting a drywall bead, the method comprising:
inserting a drywall bead into a bead-receiving channel having a shaped cross-section corresponding to the drywall bead;
advancing the bead until it contacts a length-stop surface defining a repeatable cut length;
rotating an anvil beneath the bead-receiving channel to a selected cutting angle; and
pressing an upper handle toward a lower handle to drive a blade along a blade path through the bead-receiving channel, thereby cutting the bead at the selected angle and repeatable length.

18. A method of constructing a drywall bead cutting tool, the method comprising:
pivotably connecting an upper handle to a lower handle;
mounting a blade to the upper handle; installing a bead-receiving channel having a shaped cross-section corresponding to a drywall bead;
mounting a rotatable anvil beneath the bead-receiving channel;
assembling a mechanical linkage between the upper handle and the blade;
and installing a length-stop surface configured to define a repeatable cut length.
